(19) United States
(12) Patent Application Publication
(10) Pub. No.: US 2003/0033054 A1
(43) Pub. Date: Feb. 13, 2003

(54) AUTOMATIC VENDING MACHINE TO BE CONNECTED TO NETWORK AND AUTOMATIC VENDING MACHINE-NETWORK SYSTEM

(76) Inventor: YASUHIRO YAMAZAKI, GUNMA-KEN (JP)

Correspondence Address: FISH & RICHARDSON P.C., 45 ROCKEFELLER PLAZA, SUITE 2800, NEW YORK, NY, 10111, US

(21) Appl. No.: 09/336,083

(22) Filed: Jun. 18, 1999

(51) Int. Cl. G06G 1/12

(52) U.S. Cl. 700/236; 709/211

(57) ABSTRACT

An automatic vending machine and a network to which the automatic vending machine and a computer are connected are disclosed. The automatic vending machine is loaded with TCP/IP protocol and provided with WWW browser function, so that it browses data of the automatic vending machine via the network.

### FIELD OF THE INVENTION

This invention relates to an automatic vending machine to be connected to a network and an automatic vending machine-network system, and more particularly to an automatic vending machine and a network system in which article information, article sold-out information, trouble information, etc. of the automatic vending machine can be browsed via the network from a remote administrative office.

### BACKGROUND OF THE INVENTION

It becomes popular that some number of automatic vending machines are installed for welfare facilities of a company at different places in a factory, an office building, etc. In addition, automatic vending machines are installed for improvement of customer services and sales promotion at locations such as a department store, an amusement park, etc. where a lot of people gather.

In order to administrate the automatic vending machine thus installed in accordance with the status information thereof such as sold-out, trouble, sales, etc., status-checking staffs are required to incur personnel cost, thereby making it difficult to continue such an administrative method.

For this reason, an administrative method has been carried out in which a communication system such as a private communication line is installed to administrate automatic vending machines in accordance with the status information thereof such as sold-out, trouble, sales, etc., and a personal computer installed in the automatic vending machine-administrating office is connected to the private communication line to make it possible that the status information is collected in the administrating office by the personal computer.

For this purpose, it is carried out that a private communication line is newly installed to collect the status information of the automatic vending machines.

However, this needs a considerable amount of cost. In order to avoid such cost, a telephone communication line is utilized. In such a case, the number of telephone communication lines is limited, so that a telephone communication line is temporarily used by branching it at a place where an automatic vending machine is installed. However, this is impossible in case where the telephone communication line is occupied for telephone communication.

On the other hand, a local area network(LAN) such as Ethernet has been recently installed in a factory, an office building, etc. to facilitate the transfer of information therein.

In such a situation, it is not economically advantageous to install a number of networks in the same location.

### SUMMARY OF THE INVENTION

Accordingly, it is an object of the invention to provide an automatic vending machine to be connected to a network and an automatic vending machine-network system in which information of the automatic vending machine is collected through the network, and the automatic vending machine is controlled through the network.

It is another object of the invention to provide an automatic vending machine to be connected to a network and an automatic vending machine-network system by which duplicated investment is avoided to facilitate the adoption of an administrative system of an automatic vending machine.

According to the first feature of the invention, an automatic vending machine to be connected to a network, comprises:

a control unit loaded with a standard protocol for the network, the control unit being provided with server function; and

a memory for storing data of the automatic vending machine;

wherein the control unit transmits the data via the network to a computer connected to the network, whereby the computer browses the data transmitted via the network.

In the automatic vending machine, the control unit may be loaded with TCP/IP protocols as the standard protocol, the control unit being provided with HTTP server function as the server function.

In the automatic vending machine, the computer may be a personal computer.

In the automatic vending machine, the computer may be a work station.

In the automatic vending machine, the control unit may comprise a main control unit and a sub-control unit, the main control unit being loaded with the standard protocol and provided with the server function.

In the automatic vending machine, the control unit may comprise a main control unit and a sub-control unit, the sub-control unit being loaded with the standard protocol and provided with the server function.

According to the second feature of the invention, an automatic vending machine-network system, comprises:

a network, to which a computer is connected;

one or more automatic vending machines each comprising a control unit loaded with TCP/IP protocols and a memory for storing data of the automatic vending machine, the control unit of one of the one or more automatic vending machines being provided with HTTP server function; and

one or more computers connected to the network, the one or more computers each comprising a control unit loaded with TCP/IP protocols, the control unit being provided with WWW browser function;

wherein the control unit of one of the one or more automatic vending machines transmits the data via the network to the one or more computers, whereby the one or more computers browse the data transmitted via the network.

In the automatic vending machine-network system, the one of the one or more automatic vending machine may be replaced by a server computer, the server computer comprising a control unit loaded with TCP/IP protocols and provided with HTTP server function.

### BRIEF DESCRIPTION OF THE DRAWINGS

The invention will be described in more detail in conjunction with appended drawings, wherein:

FIG. 1A is a schematic diagram showing an automatic vending machine connected to a network in a preferred embodiment according to the invention,

FIG. 1B is a block diagram showing the automatic vending machine in FIG. 1A, and

FIG. 2A is a block diagram showing an automatic vending machine connected to a network in another preferred embodiment according to the invention.

### DESCRIPTION OF THE PREFERRED EMBODIMENTS

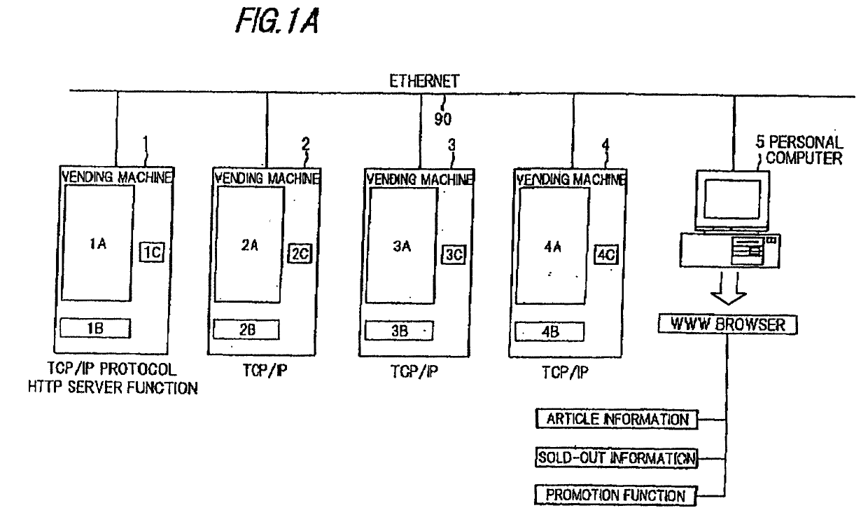

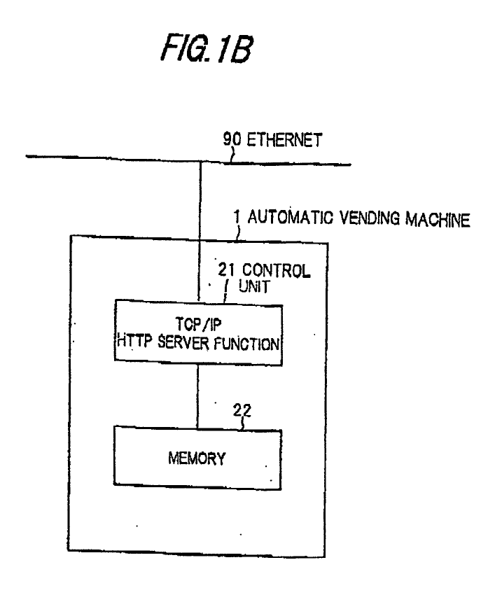

FIG. 1A shows an automatic vending machine-network system in a preferred embodiment according to the invention. The automatic vending machine-network system comprises automatic vending machines 1, 2, 3 and 4 having article displays 1A, 2A, 3A and 4A, article take-out openings 1B, 2B, 3B and 4B, and operating panels 1C, 2C, 3C and 4C, and a personal computer 5, wherein the automatic vending machines 1, 2, 3 and 4 are connected to Ethernet 90, and the personal computer 5 is also connected to Ethernet 90.

The vending machine 1 is loaded with TCP/IP(Transmission Control protocol/Internet Protocol) which are standard protocols for a computer network. For these protocols, the automatic vending machine 1 can transmit and receive data to the personal computer 5 connected to Ethernet 90 and receive data therefrom.

The automatic vending machine 1 is also equipped with HTTP (Hyper Text Transfer Protocol) which has been used in Internet, so that the automatic vending machine 1 describes data thereof such as article information, sold-out information, sales information, etc on home page which was opened by transferring the data thereto.

FIG. 1B shows the automatic vending machine 1 connected to Ethernet 90 comprises a control unit 21 loaded with TCP/IP protocol and provided with HTTP server function, and a memory for storing data of the automatic vending machine 1 and data transferred from the automatic vending machines 2 to 4.

The personal computer 5 can read and obtain the data of the automatic vending machine 1 on the home page in accordance with WWW browser software loaded in the personal computer 5, and it can transmit other data to the automatic vending machine 1.

In the preferred embodiment, cost and time to develop new softwares can be saved by utilizing existing softwares.

The automatic vending machines 2 to 4 have the same structure and function as the automatic vending machine 1. In the preferred embodiment, they are only required to be loaded with softwares such as TCP/IP protocol by which they can access to Ethernet 90.

However, they are not required to be loaded with WWW browser. For this structure, the automatic vending machines 2 to 4 transmit own data via Ethernet 90 to the automatic vending machine 1, and receive information via Ethernet 90 from the vending machine 1, so that information of the automatic vending machine 2 to 4 and the automatic vending machine 1 can be browsed on the home page in accordance with HTTP server function of the automatic vending machine 1 by the personal computer 5.

In this manner, the information of the automatic vending machines 1 to 4 relating to articles to be sold, trouble, sold-out state, sales amount, etc. can be obtained from the personal computer 5 installed at an administrative office the information can be transferred via Internet to remote offices, where Ethernet 90 is connected to Internet, and personal computers are connected to Internet at the remote offices. In the preferred embodiment, the personal computer 5 and the personal computers of the remote offices may be work stations.

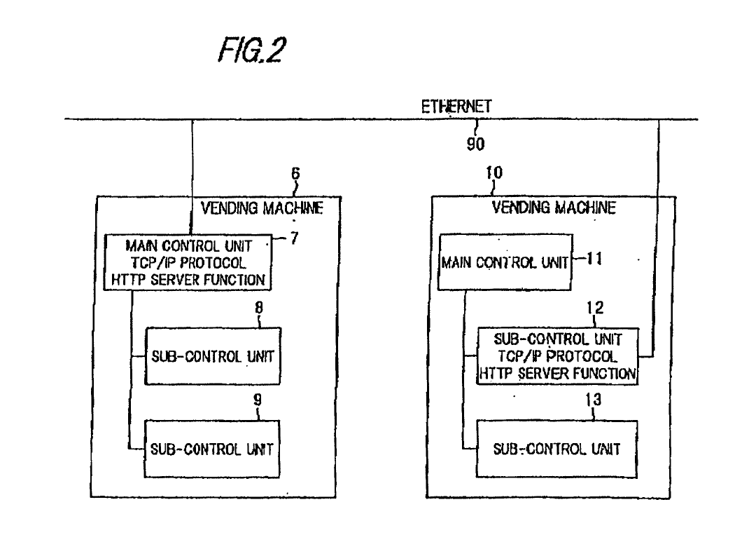

FIG. 2 shows automatic vending machines 6 and 10 connected to Ethernet 90 in another preferred embodiment according to the invention.

In this preferred embodiment, the automatic vending machines 6 and 10 comprise main control unit 7 and 11, sub-control unit 8 and 9, and 12 and 13, respectively.

In the automatic vending machine 6, the main control unit 7 is connected to Ethernet 90 and loaded with TCP/IP protocol and provided with HTTP server function, and, in the automatic vending machine 10, the sub-control unit 12 is connected to Ethernet 90 and loaded with TCP/IP and provided with HTTP server function.

In these preferred embodiments, the automatic vending machines 1, 6 and 10 have HTTP server function. However, a server computer having HTTP server function may be connected to a network which is embodied as Ethernet 90. In such a case, information of each automatic vending machine is transferred to the server computer, so that the server computer describes the information on its own home page, and a personal computer connected to the network can browse the information on the home page of the server computer.

In the invention, an automatic vending machine is loaded with the standard protocol for a computer network, so that the automatic vending machine can transmit the data to the computer network and receive the data therefrom, In addition, the automatic vending machine has server function in accordance with a Protocol for Internet, so that a personal computer connected to the computer network can browse the data on a home page opened by the automatic vending machine. In this manner, cost, time and the necessity to develop new softwares can be saved by using softwares which have been already existed to be available, and used and evaluated by users in the world.

Any computer connected to the computer network can access to the automatic vending machine, because widely used softwares are used, and specifications are unified.

Where the computer network is connected to Internet, data can be transferred among offices, even if the offices are located at remote places.

A duplicated equipment is avoided, and initial investment and maintenance cost are reduced, because a factory network or an office network which has been recently developed can be used without changing its structure to provide an automatic vending machine-network.

In accordance with the loading of TCP/IP protocol in the automatic vending machine, the transmission and receipt of data relative to the computer network can be practically carried out.

Further, the HTTP server function in the automatic vending machine makes it possible that data of automatic vending machines can be browsed from a computer connected to the network.

In this manner, cost, time and the necessity to develop new softwares can be saved by using TCP/IP protocol and HTTP server function which have been already existed to be available, and used and evaluated by users in the world.

Where Ethernet is used as the computer network, softwares and equipments are obtained with less cost to provide a highly reliable system, because Ethernet is widely used with practically high reputation.

The same advantages as described above are also obtained in the use of WWW browser and the provision of a server computer in place of an automatic vending machine having HTTP server function.

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching here is set forth.

What is claimed is:

1. An automatic vending machine to be connected to a network, comprising:
a control unit loaded with a standard protocol for said network, said control unit being provided with server function;
a memory for storing data of said automatic vending machine;
wherein said control unit transmits said data via said network to a computer connected to said network, whereby said computer browses said data transmitted via said network.

2. The automatic vending machine as defined in claim 1, wherein:
said control unit is loaded with TCP/IP protocol as said standard protocol, said control unit being provided with HTTP server function as said server function.

3. The automatic vending machine as defined in claim 1, wherein:
said computer is a personal computer.

4. The automatic vending machine as defined in claim 1, wherein;
said computer is a work station.

5. The automatic vending machine as defined in claim 1, wherein:
said control unit comprises a main control unit and a sub-control unit, said main control unit being loaded with said standard protocol and provided with said server function.

6. The automatic vending machine as defined in claim 1, wherein:
said control unit comprises a main control unit and a sub-control unit, said sub-control unit being loaded with said standard protocol and provided with said server function.

7. An automatic vending machine-network system, comprising:
a network, to which a computer is connected;
one or more automatic vending machines each comprising a control unit loaded with TCP/IP protocol and a memory for storing data of said automatic vending machine, said control unit of one of said one or more automatic vending machines being provided with HTTP server function; and
one or more computers connected to said network, said one or more computers each comprising a control unit loaded with TCP/IP protocols, said control unit being provided with WWW browser function;
wherein said control units of automatic vending machines transmit said data via said network to said one or more computers, whereby said one or more computers browse said data transmitted via said network.

8. The automatic vending machine-network system as defined in claim 7, wherein:
said one of said one or more automatic vending machines is replaced by a server computer, said server computer comprising a control unit loaded with TCP/IP protocols and provided with HTTP server function.
